(19) United States
(12) Patent Application Publication
(10) Pub. No.: US 2011/0143745 A1
(43) Pub. Date: Jun. 16, 2011

(54) Method for setting mobility state of user equipment

(75) Inventors: Yaying Wang, Shenzhen (CN); Hao Wu, Shenzhen (CN)

(73) Assignee: ZTE CORPORATION, Shenzhen, Guangdong (CN)

(21) Appl. No.: 13/055,714

(22) PCT Filed: Aug. 11, 2009
(86) PCT No.: PCT/CN2009/073183

§ 371 Date: Jan. 25, 2011

(30) Foreign Application Priority Data
Aug. 11, 2008 (CN) 200810210242.8

(51) Int. Cl. H04W 8/02

(52) U.S. Cl. 455/422.1

(57) ABSTRACT

A method for setting a mobility state of a user equipment is provided in the present invention. The method comprises the steps: in the process of the user equipment performing a mobility state evaluation, if the user equipment receives new evaluation parameters different from the currently used evaluation parameters, the user equipment continues keeping the current mobility state, or sets the mobility state of the user equipment to be a normal mobility state, or converts the current mobility state according to a corresponding relation. When evaluation parameters change in the process of the user equipment performing the mobility state evaluation, the method for setting the mobility state of the user equipment in the present invention can perform control processing effectively so as to avoid the problem that the setting of the mobility state of the user equipment cannot be determined.

### TECHNICAL FIELD

The present invention relates to the field of mobile communications, particularly to a method for setting a mobility state of a user equipment.

### BACKGROUND

In a mobile communication system, the speed of a user equipment can influence the quality of service provided by a network, especially in the process of cell reselection or switching, if a user equipment in a high-speed motion adopts control parameters as same as those used for a user equipment in a normal motion, the user equipment may have been out of the coverage of a serving cell before it reselects or switches to a target cell. Thus, in an existing mobile communication system, the cell reselection or switching is performed depending on a mobility state of a user equipment, that is, control parameters of motion speed.

Two evaluation parameters are defined in an existing mobile communication system: is T and N. T is a timer used in a mobility state evaluation of a user equipment, and N is a predefined threshold value. In the process of the mobility state evaluation, the user equipment counts the times of the execution of the cell reselection or switching within a time T; if the counted times exceeds N, the user equipment is considered to be in a high-speed mobility state; otherwise, the user equipment is considered to be in a normal mobility state.

However, if the user equipment enters a cell with different evaluation parameters during an evaluation, and if the evaluation parameters are broadcasted in system messages of the cell according to existing protocols, the user equipment will inevitably read new broadcast information when entering the cell, and update the parameters stored in the user equipment. At this time, the user equipment cannot determine whether a mobility state reset is needed as it enters a new cell, additionally, because parameters different from the previous ones are obtained while this mobility state evaluation has not been completed, the setting of a subsequent mobility state of the user equipment cannot be determined either, and as a result, the user equipment cannot determine which kind of parameters (corresponding to a mobility state respectively) should be used during the cell reselection or switching.

### SUMMARY

The technical problem that the present invention intends to resolve is to provide a method for setting a mobility state of a user equipment, which resolves the problem that, in the process of the user equipment performing a mobility state evaluation, the setting of the mobility state of the user equipment cannot be determined because of evaluation parameters changes.

In order to resolve the above-mentioned technical problem, the present invention provides a method for setting a mobility state of a user equipment, which comprises the following steps: if the user equipment receives new evaluation parameters different from the currently used evaluation parameters in the process of performing a mobility state evaluation, the user equipment continues keeping the current mobility state.

Further, the method may also have the following characteristics:

after receiving the new evaluation parameters which are different from the currently used evaluation parameters, the user equipment ends the evaluation and adopts the new evaluation parameters to perform a next mobility state evaluation, or continues the completion of the mobility state evaluation by using the new evaluation parameters.

Further, the method may also have the following characteristics:

the step that the user equipment continues the completion of the mobility state evaluation by using the new evaluation parameters refers to that: the user equipment keeps the current count value of a counter, resets the timing time of a timer to be the difference between a new timing time and the timing time which the timer has currently finished, counts the times of the user equipment performing cell reselection or switching before the reset timing time is reached, stops the timer after the reset timing time is reached, evaluates an obtained count value by using a new threshold value, and sets a corresponding mobility state according to the result of the evaluation.

Further, the method may also have the following characteristics:

the timer is stopped when the new timing time is not greater than the timing time which the timer has currently finished.

Further, the method may also have the following characteristics:

time parameters contained in the evaluation parameters comprise trigger time and delay time; and

the completion of the mobility state evaluation refers to the reaching of the time timed by the timer for the trigger time, or the reaching of the time timed by the timer for the delay time.

In order to resolve the above-mentioned technical problem, the present invention further provides a method for setting a mobility state of a user equipment, which comprises the following steps: if the user equipment receives new evaluation parameters different from the currently used evaluation parameters in the process of performing a mobility state evaluation, the mobility state of the user equipment is set to is be a normal mobility state.

Further, the method may also have the following characteristics:

after receiving the new evaluation parameters which are different from the currently used evaluation parameters, the user equipment continues the completion of the mobility state evaluation by adopting the evaluation parameters used for the current mobility state evaluation, and then performs a next mobility state evaluation by using the evaluation parameters newly received during the mobility state evaluation.

Further, the method may also have the following characteristics:

time parameters contained in the evaluation parameters comprise trigger time and delay time; and

the completion of the mobility state evaluation refers to the reaching of the time timed by the timer for the trigger time, or the reaching of the time timed by a timer for the delay time.

In order to resolve the above-mentioned technical problem, the present invention further provides a method for setting a mobility state of a user equipment, which comprises the following steps: if the user equipment receives new evaluation parameters different from the currently used evaluation parameters in the process of performing a mobility state evaluation, the user equipment converts the current mobility state according to a corresponding relation.

Further, the method may also have the following characteristics:

the corresponding relation refers to that a high-speed mobility state in a universal mobile telecommunications system (UMTS) is corresponding to a high-speed or medium-speed mobility state in a long term evolution (LTE) system, and that a normal mobility state in a UMTS is corresponding to that in an LTE system.

Further, the method may also have the following characteristics:

after receiving the new evaluation parameters which are different from the currently used evaluation parameters, the user equipment continues the completion of the mobility state evaluation by adopting the evaluation parameters used for the current mobility state evaluation, and then performs a next mobility state evaluation by using the new evaluation parameters; or ends the mobility state evaluation and performs a next mobility state evaluation by using the new evaluation parameters; or continues the completion of the mobility state evaluation by using the new evaluation parameters.

Further, the method may also have the following characteristics:

the step that the user equipment continues the completion of the mobility state evaluation by using the new evaluation parameters refers to that: the user equipment keeps the current count value of a counter, resets the timing time of a timer to be the difference between a new timing time and the timing time which the timer has currently finished, counts the times of the user equipment performing cell reselection or switching before the reset timing time is reached, stops the timer after the reset timing time is reached, evaluates an obtained count value by using a new threshold value, and sets a corresponding mobility state according to the result of the evaluation.

Further, the method may also have the following characteristics:

the timer is stopped when the new timing time is not greater than the timing time which the timer has currently finished.

Further, the method may also have the following characteristics:

time parameters contained in the evaluation parameters comprise trigger time and delay time; and

the completion of the mobility state evaluation refers to the reaching of the time timed by a timer for the trigger time, or the reaching of the time timed by a timer for the delay time.

According to the method for setting a mobility state of a user equipment in the present invention, in the process of the user equipment performing a mobility state evaluation, control processing can be effectively performed when evaluation parameters are changed, so as to avoid the problem that the setting of the mobility state of the user equipment cannot be determined.

### BRIEF DESCRIPTION OF THE DRAWINGS

FIG. 1 is a flowchart of a method for controlling a mobility state evaluation of a user equipment according to a first embodiment of the present invention;

FIG. 2 is a flowchart of a method for controlling a mobility state evaluation of a user equipment according to a second embodiment of the present invention;

FIG. 3 is a flowchart of a method for controlling a mobility state evaluation of a user equipment according to a third embodiment of the present invention;

FIG. 4 is a flowchart of a method for controlling a mobility state evaluation of a user equipment according to a fourth embodiment of the present invention;

FIG. 5 is a flowchart of a method for controlling a mobility state evaluation of a user equipment according to a fifth embodiment of the present invention; and

FIG. 6 is a flowchart of a method for controlling a mobility state evaluation of a user equipment according to a sixth embodiment of the present invention.

### DETAILED DESCRIPTION

The present invention provides a method for setting a mobility state of a user equipment, the basic conception of which lies in that: when the user equipment receives different evaluation parameters during the process of performing a mobility state evaluation, the user equipment explicitly defines the setting of the current mobility state and a method of a following mobility state evaluation, so as to avoid the problem that the setting of the mobility state of the user equipment cannot be determined.

Currently, the evaluation parameters for the user equipment to perform a mobility state evaluation are generally included in system messages of a cell, and sometimes in measurement control signaling distributed by a network side, thus, the user equipment can obtain the evaluation parameters when reading the system messages of the cell or receiving the measurement control signaling distributed by the network side. The parameters for the mobility state evaluation comprise trigger time Tmax, delay time Thyst, high speed threshold value Nh and medium speed threshold value Nm.

However, in some cases the user equipment may obtain new evaluation parameters which are not totally identical to the ones adopted for the current mobility state evaluation. For example, in the process of the user equipment performing a mobility state evaluation, when cell reselection occurs in an idle mode, as a new cell may use different evaluation parameters, the user equipment may obtain evaluation parameters which are not totally identical to the currently used evaluation parameters when reading the system messages of the reselected new cell; or when the user equipment receives measurement control signaling distributed by the network side in a connection mode, as a cell which is switched to may adopt different evaluation parameters, the evaluation parameters contained in the control signaling distributed by the network side may not be totally identical to the current ones; or when the user equipment initiates a service under the control of the network side and enters a connection mode from an idle mode, as in the connection mode the system may use parameters different from those used in the idle mode, the evaluation parameters contained in the control signaling distributed by the network side may not be totally identical to the current ones; or when the user equipment ends a service and enters an idle mode from a connection mode, as in the idle mode the network may use parameters different from those used in the connection mode, evaluation parameters contained in cell information read by the user equipment in the idle mode may not be totally identical to the current ones. At this time, the user equipment is required to specify the setting of the current mobility state and a method for a following mobility state evaluation so that the user equipment can determine which kind of parameters (corresponding to a mobility state respectively) should be used during cell reselection or switching.

### Embodiment 1

If switching occurs between different modes, especially from an idle mode to a connection mode, when a user equipment receives new evaluation parameters which are not totally identical to the current ones, the parameters currently set for the mobility state of the user equipment have little reference value in evaluating a following mobility is state because parameters configured by a network side for a cell are generally much different in different modes, and the user equipment has a relatively high requirement on the quality of services in a connection mode. Considering the situation above, preferably, an embodiment of the present invention recommends, but not in a limiting way, setting the mobility state of the user equipment to be a normal mobility state after new evaluation parameters which are not totally identical to the current ones are received.

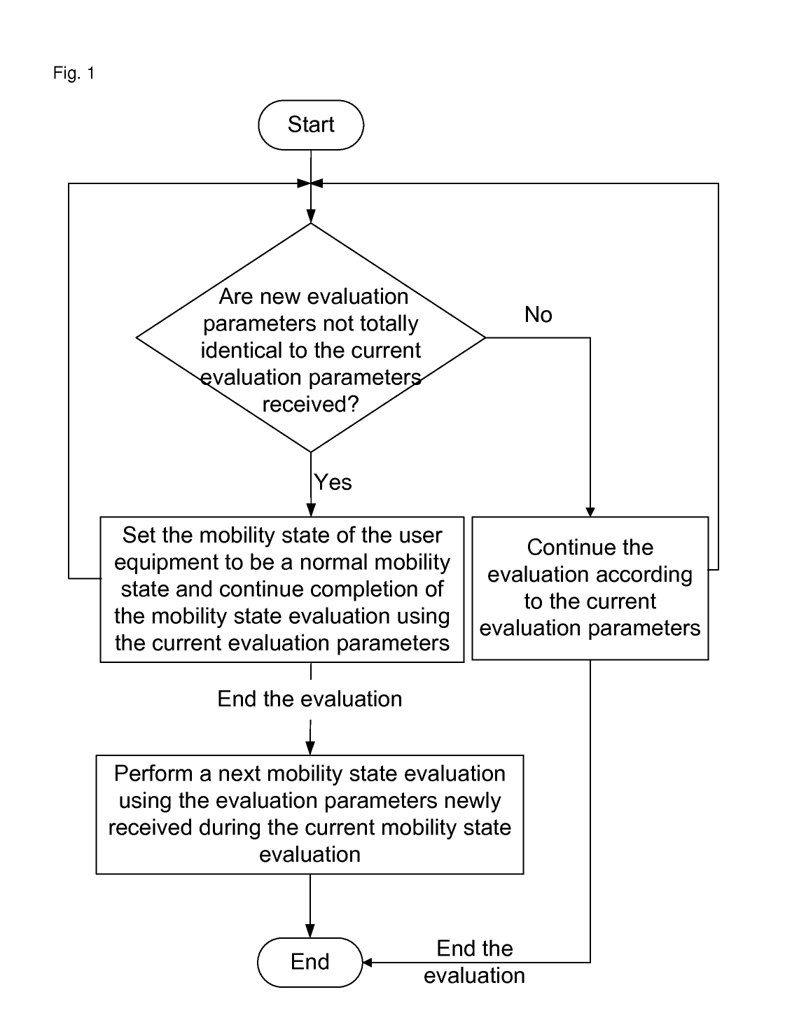

Referring to FIG. 1, if switching between different modes occurs when the user equipment receives new evaluation parameters which are not totally identical to the current ones, the user equipment sets the current mobility state to be a normal mobility state, keeps the current count value of a counter and the remaining timing time of a timer, performs no evaluation parameter update, and continues the completion of the mobility state evaluation by using the current evaluation parameters.

Assuming that the evaluation parameters used in the current mobility state evaluation performed by the user equipment are as follows: trigger time Tmax1, delay time Thyst1, high speed threshold vale Nh1, and medium speed threshold value Nm1. In a complete mobility state evaluation, the user equipment activates a timer after a mobility state evaluation is triggered, the timing time is Tmax1, and a counter can be used before the trigger time is reached to count the times the user equipment performs cell reselection or switching; the timer and the counter are stopped when the trigger time is reached, and the high speed threshold value Nh1 and the medium speed threshold value Nm1 are used to evaluate a count value of the counter. In particular, the user equipment is determined to be in a medium speed mobility state if the count value of the counter is greater than or equal to the medium speed threshold value Nm1 but smaller than the high speed threshold value Nh1; the user equipment is determined to be in a high speed mobility state if the count value of the counter is greater than or equal to the high speed threshold value Nh1; and the user equipment is determined to be in a normal mobility state if the count value of the counter is smaller than the medium speed threshold value Nm1. It should be noted here that: if the mobility state currently is kept by the user equipment is a normal state, a corresponding mobility state is set according to the result of the evaluation, otherwise, a corresponding mobility state is set according to the result of the evaluation when the result of the evaluation is medium speed or high speed. However, when the result of the evaluation is normal, the user equipment reactivates the timer, setting a timing time as Thyst1, continues counting the times the user equipment performs cell reselection or switching within the delay time Thyst1 , evaluates the sum of the count values obtained within the time Tmax1 and the time Thyst1, and sets a corresponding mobility state according to the result of the evaluation.

No influence is caused to the evaluation if the user equipment receives new evaluation parameters which are not totally identical to the current ones during the evaluation process.

After the evaluation is completed, the evaluation parameters are updated to be the evaluation parameters newly received before the completion of the mobility state evaluation, and a following mobility state evaluation is performed by using the updated evaluation parameters.

### Embodiment 2

If no switching occurs between different modes when a user equipment receives new evaluation parameters which are not totally identical to the current ones, the current mobility state have certain reference value in evaluating a following mobility state because parameters configured by a network side for a cell are generally little different in the same mode. Considering the situation above, preferably, an embodiment of the present invention recommends, but not in a limiting way, keeping the current mobility state of the user equipment after the new evaluation parameters are received.

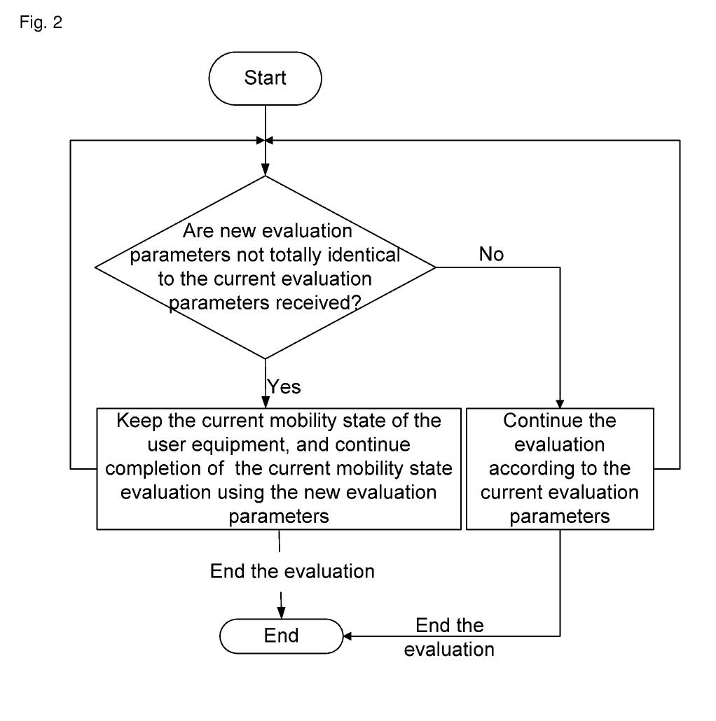

Referring to FIG. 2, if no mode switching occurs when the user equipment receives new evaluation parameters which are not totally identical to the current ones, the user equipment keeps the current mobility state, reserves the current count value of a counter, updates the evaluation parameters with the new ones, and continues the completion of the mobility state evaluation by using the updated evaluation parameters.

Considering that the mobility state evaluation has not been completed when the new evaluation parameters are received, the currently finished evaluation is used as one part of the mobility state evaluation and still has certain reference value, thus, the finished evaluation is kept, that is, the current count value of a counter and the timing time a timer has finished are kept, wherein the timing time the timer has finished is the difference between the timing time before the update and the current remaining timing time of the timer; the evaluation parameters are updated with the new ones, the timing time of the timer is reset according to an updated timing time, which is the difference between the updated timing time and the timing time the timer has currently finished; the counting for the times of cell reselection or switching the user equipment carries out is continued before the reset timing time is reached; the timer is stopped after the reset timing time is reached; an obtained count value is evaluated by using an updated threshold value, and corresponding processing is performed according to the result of the evaluation. As the timer may be timing for the trigger time or the delay time when the new evaluation parameters are received, the following two cases should be considered respectively.

If the timer is timing for the trigger time Tmax1 when the user equipment receives the new evaluation parameters (trigger time Tmax2, delay time Thyst2, high speed threshold value Nh2, and medium speed threshold value Nm2), the current remaining timing time of the timer is x, and the current count value of the counter is y, then the timing time of the timer is reset to be the difference between the updated trigger time Tmax2 and the timing time the timer has currently finished, while the timing time the timer has currently finished is the difference between the trigger time Tmax1 before the update and the current remaining timing time x of the timer, evaluation parameters are updated, and the subsequent part of the mobility state evaluation is performed according to the updated evaluation parameters. Preferably, it can be determined whether the updated trigger time Tmax2 is greater than the timing time the timer has currently finished before the reset of the timing time of the timer; if the result of the determination is that the updated trigger time Tmax2 is not greater than the timing time the timer has currently finished, the timer is stopped, the updated high speed threshold value Nh2 and the medium speed threshold value Nm2 are adopted to evaluate the current count value y of the counter. In particular, the mobility state of the user equipment is determined to be medium speed if the count value y of the counter is greater than or equal to the medium speed threshold value Nm2 but smaller than the high speed threshold value Nh2; the mobility state of the user equipment is determined to be high speed if the count value y of the counter is greater than or equal to the high speed threshold value Nh2; and the mobility state of the user equipment is determined to be normal if the count value y of the counter is smaller than the medium speed threshold value Nm2. If the result of the determination is that the updated trigger time Tmax2 is greater than the timing time the timer has currently finished, the counting for the times of cell reselection or switching the user equipment carries out is continued before the reset timing time is reached, the timer is stopped after the reset timing time is reached, and the updated high speed threshold value Nh2 and the medium speed threshold value Nm2 are adopted to evaluate the count value of the counter. It should be noted here that: if the mobility state currently kept by the user equipment is a normal state, a corresponding mobility state is set according to the result of the evaluation; otherwise, a corresponding mobility state is set according to the result of the evaluation when the result of the evaluation is medium speed or high speed; however, when the result of the evaluation is normal, the user equipment reactivates the timer, setting a timing time as Thyst2, continues counting the times the user equipment performs cell reselection or switching within the delay time Thyst2, evaluates the sum of the count values obtained within the time Tmax2 and the time Thyst2, and sets a corresponding mobility state according to the result of the evaluation.

Assuming that the timer is timing for the delay time Thyst1 when the user equipment receives the new evaluation parameters (trigger time Tmax2, delay time Thyst2, high speed threshold value Nh2, and medium speed threshold value Nm2), the current remaining timing time of the timer is x, and the current count value of the counter is y, then by using the method above, the timing time of the timer is reset to be the difference between the updated delay time Thyst2 and the timing time the timer has currently finished, while the timing time the timer has currently finished is the difference between the delay time Thyst1 before the update and the current remaining timing time x of the timer, the evaluation parameters are updated, and the subsequent part of the mobility state evaluation is performed according to the updated evaluation parameters. The timer is stopped after the reset timing time is reached, and the updated high speed threshold value Nh2 and the medium speed threshold value Nm2 are adopted to evaluate the count value of the counter, and a corresponding mobility state is set according to the result of the evaluation; preferably, it can be determined whether the updated delay time Thyst2 is greater than the delay time the timer has currently finished before the reset of the timing time, if the result of the determination is that the updated delay time Thyst2 is not greater than the delay time the timer has currently finished, the timer is stopped; otherwise, the timing time of the timer is reset according to the method above, and the evaluation is continued within the reset timing time.

### Embodiment 3

If no switching occurs between different modes when a user equipment receives new evaluation parameters which are not totally identical to the current ones, the current mobility state have certain reference value in a following mobility state evaluation because parameters configured by a network side for a cell are generally little different in the same mode. Considering the situation above, preferably, an embodiment of the present invention recommends, but not in a limiting way, keeping the current mobility state of the user equipment after the new evaluation parameters are received.

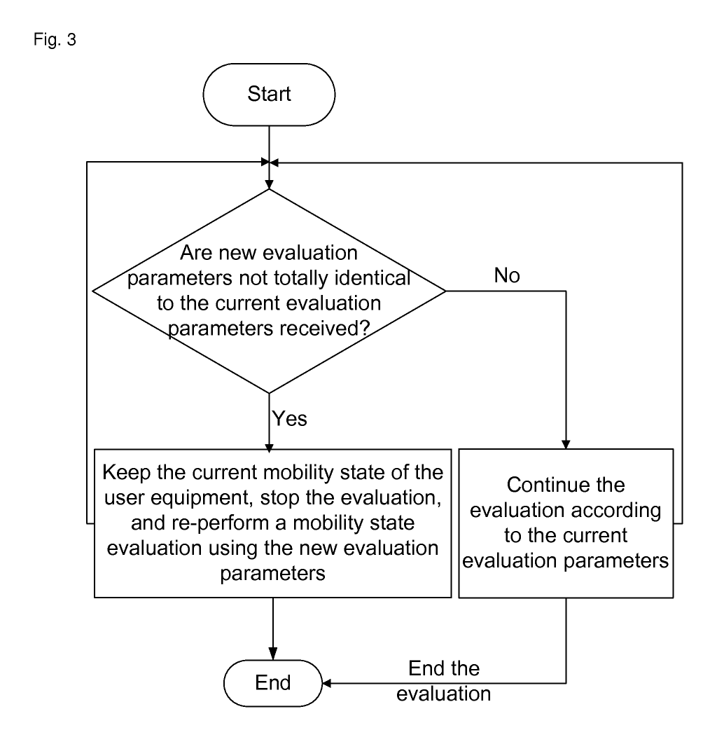

Referring to FIG. 3, if no mode switching occurs when the user equipment receives new evaluation parameters which are not totally identical to the current ones, the user equipment keeps the current mobility state, resets a count value and a timer, ends the mobility state evaluation, updates evaluation parameters with the received new evaluation parameters, and re-performs a mobility state evaluation by using the updated evaluation parameters. The method for re-performing a mobility state evaluation by using new evaluation parameters is the same as that described in the embodiment 1, so no more description is given here.

### Embodiment 4

If cell reselection occurs in a different system when a user equipment receives new evaluation parameters which are not totally identical to the current ones, parameters configured by a network side for a cell are generally much different because systems are different, and in a long term evolution (LTE) system the mobility states of a user equipment are divided into high speed, medium speed and normal, and in a universal mobile telecommunications system (UMTS) the mobility states of the user equipment are divided into high speed and normal. Considering the situation above, preferably, an embodiment of the present invention recommends, but not in a limiting way, the user equipment to perform a mobility state conversion according to a corresponding relation if reselection occurs in a different system after the new evaluation parameters which are not totally identical to the current ones are received.

The corresponding relation refers to that: a high-speed mobility state in the UMTS is corresponding to a high-speed or medium-speed mobility state in the LTE system, and a normal mobility state in the UMTS is corresponding to that in the LTE system. In particular, for example, when the user equipment switches cell reselection from the UMTS to the LTE system, according to the corresponding relation above, the state value high speed in the UMTS can be converted to the state value high speed in the LTE system, and the state value normal speed in the UMTS can be converted to the state value normal speed in the LTE system; or the state value high speed in the UMTS can be converted to the state value medium speed in the LTE system, and the state value normal speed in the UMTS is converted to the state value normal speed in the LTE system; for another example, when the user equipment switches cell reselection from the LTE system to the UMTS, according to the corresponding relation above, the state values high speed and medium speed in the LTE system can be converted to the state value high speed in the UMTS, and the state value normal in the LTE system can be converted to the state value normal in the UMTS. Wherein the state values are descriptions for the mobility states of the user equipment, which can be enumerative types, such as high speed, medium speed and normal.

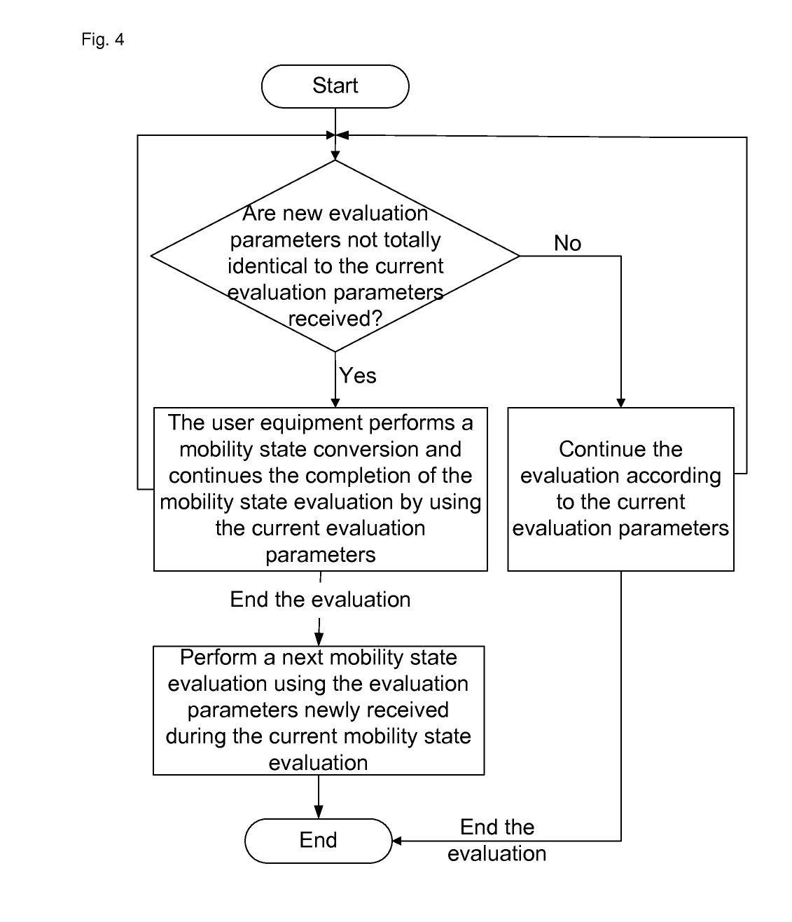

Referring to FIG. 4, if cell reselection occurs in a different system when the user equipment receives new evaluation parameters which are not totally identical to the current ones, the user equipment performs a mobility state conversion according to the mobility state conversion method above, keeps the current count value of a counter and the remaining timing time of a timer, updates no evaluation parameter, and continues the completion of the mobility state evaluation by using the current evaluation parameters.

The user equipment performs a mobility state evaluation according to the method given in the first embodiment, and no influence is caused to the evaluation if new evaluation parameters which are not totally identical to the current ones are received during the mobility state evaluation. After the mobility state evaluation is completed, the evaluation parameters are updated to be the evaluation parameters newly received before the completion of the mobility state evaluation, and a following mobility state evaluation is performed by using the updated evaluation parameters.

### Embodiment 5

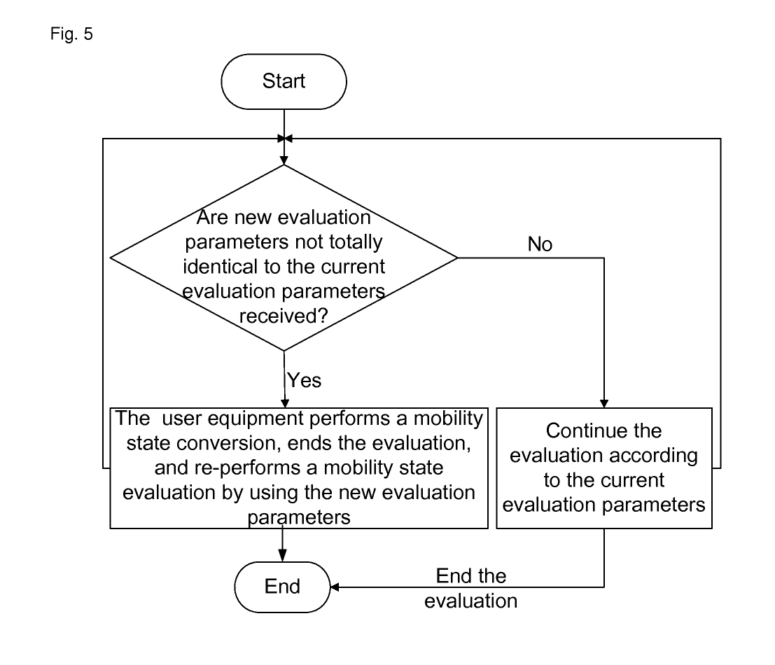

Referring to FIG. 5, in the process of a user equipment performing a mobility state evaluation, if cell reselection occurs in a different system when the user equipment receives new evaluation parameters which are not totally identical to the currently used evaluation parameters, the user equipment may perform a mobility state conversion according to the mobility state conversion method of the fourth embodiment, and at the same time, the user equipment resets a count value and a timer, ends the mobility state evaluation, and then updates the evaluation parameters with the received new evaluation parameters, and re-performs a mobility state evaluation by using the updated evaluation parameters.

The method for re-performing a mobility state evaluation method by using new evaluation parameters is the same as that described in the first embodiment, so no more description is given here.

### Embodiment 6

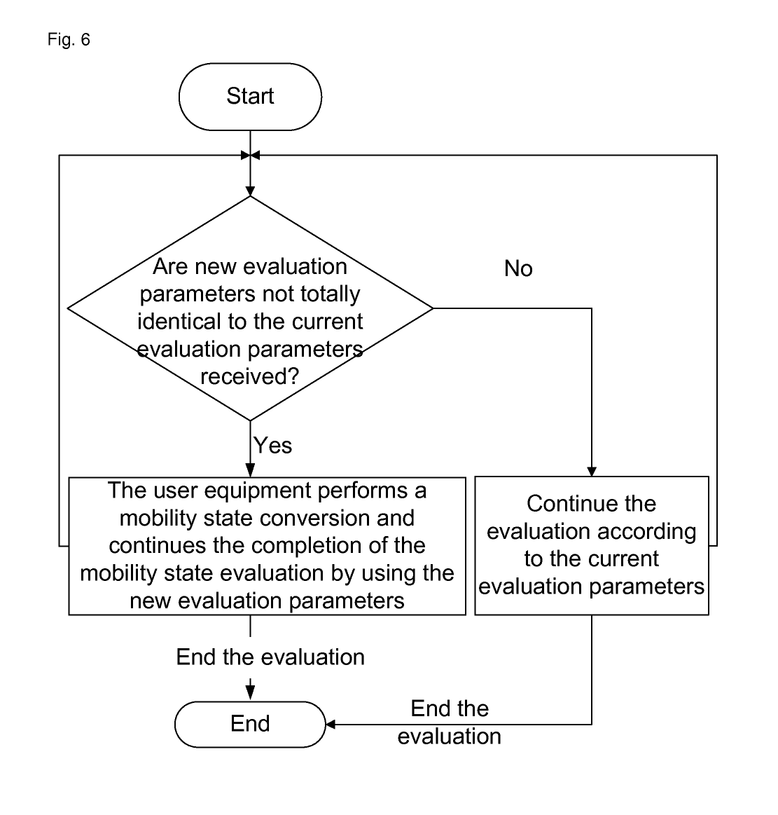

Referring to FIG. 6, in the process of a user equipment performing a mobility state evaluation, if cell reselection occurs in a different system when the user equipment receives new evaluation parameters which are not totally identical to the currently used evaluation parameters, the user equipment may perform a mobility state conversion according to the mobility state conversion method of the fourth embodiment, and at the same time, the user equipment keeps the current count value of a counter, updates the evaluation parameters with the new ones, and continues the completion of the mobility state evaluation by using the updated evaluation parameters.

Considering that the mobility state evaluation has not been completed when the new evaluation parameters are received, the currently finished evaluation is used as one part of the mobility state evaluation and still has certain reference value, thus, the finished evaluation is kept, that is, the current count value of the counter is kept, the timing time of the timer is reset according to the method of the second embodiment, the counting for the times of the cell reselection or switching the user equipment carries out is continued before the reset timing time is reached, the timer is stopped after the reset timing time is reached, and an evaluation and corresponding processing are performed on an obtained count value by using updated threshold values.

Of course, the present invention may have many other embodiments, various modifications and variations can be devised by those skilled in the art without departing from the spirit and the essence of the present invention, and it should be understood that these modifications and variations belong to the protection scope of the claims in the present invention.

### INDUSTRIAL APPLICABILITY

In a method for setting a mobility state of a user equipment provided in the present invention, the user equipment can perform control processing effectively when evaluation parameters are changed during performing a mobility state evaluation, so as to avoid the problem that the setting of the mobility state of the user equipment cannot be determined.

What is claimed is:

1. A method for setting a mobility state of a user equipment, comprising:
if the user equipment receives new evaluation parameters different from the currently used evaluation parameters in the process of performing a mobility state evaluation, the user equipment continuing keeping the current mobility state.

2. The method according to claim 1, wherein
after receiving the new evaluation parameters which are different from the currently used evaluation parameters, the user equipment ends the evaluation and adopts the new evaluation parameters to perform a next mobility state evaluation, or continues the completion of the mobility state evaluation by using the new evaluation parameters.

3. The method according to claim 2, wherein
the step that the user equipment continues the completion of the mobility state evaluation by using the new evaluation parameters refers to that: the user equipment keeps the current count value of a counter, resets the timing time of a timer to be the difference between a new timing time and the timing time which the timer has currently finished, counts the times of the user equipment performing cell reselection or switching before the reset timing time is reached, stops the timer after the reset timing time is reached, evaluates an obtained count value by using a new threshold value, and sets a corresponding mobility state according to the result of the evaluation.

4. The method according to claim 3, wherein
the timer is stopped when the new timing time is not greater than the timing time which the timer has currently finished.

5. The method according to claim 2, wherein
time parameters contained in the evaluation parameters comprise trigger time and delay time; and
the completion of the mobility state evaluation refers to the reaching of the time timed by a timer for the trigger time, or the reaching of the time timed by a timer for the delay time.

6. A method for setting a mobility state of a user equipment, comprising:
if the user equipment receives new evaluation parameters different from the currently used evaluation parameters in the process of performing a mobility state evaluation, the mobility state of the user equipment being set to be a normal mobility state.

7. The method according to claim 6, wherein
after receiving the new evaluation parameters which are different from the currently used evaluation parameters, the user equipment continues the completion of the mobility state evaluation by adopting the evaluation parameters used for the current mobility state evaluation, and then performs a next mobility state evaluation by using the evaluation parameters newly received during the mobility state evaluation.

8. The method according to claim 7, wherein
time parameters contained in the evaluation parameters comprise trigger time and delay time; and
the completion of the mobility state evaluation refers to the reaching of the time timed by a timer for the trigger time, or the reaching of the time timed by a timer for the delay time.

9. A method for setting a mobility state of a user equipment, comprising:
if the user equipment receives new evaluation parameters different from the currently used evaluation parameters in the process of performing a mobility state evaluation, the user equipment converting the current mobility state according to a corresponding relation.

10. The method according to claim 9, wherein the corresponding relation refers to that:
a high-speed mobility state in a universal mobile telecommunications system (UMTS) is corresponding to a high-speed or medium-speed mobility state in a long term evolution (LTE) system, and that
a normal mobility state in a UMTS is corresponding to that in an LTE system.

11. The method according to claim 9, wherein
after receiving the new evaluation parameters which are different from the currently used evaluation parameters, the user equipment continues the completion of the mobility state evaluation by adopting the evaluation parameters used for the current mobility state evaluation, and then performs a next mobility state evaluation by using the new evaluation parameters; or ends the mobility state evaluation and performs a next mobility state evaluation by using the new evaluation parameters; or continues the completion of the mobility state evaluation by using the new evaluation parameters.

12. The method according to claim 11, wherein
the step that the user equipment continues the completion of the mobility state is evaluation by using the new evaluation parameters refers to that: the user equipment keeps the current count value of a counter, resets the timing time of a timer to be the difference between a new timing time and the timing time which the timer has currently finished, counts the times of the user equipment performing cell reselection or switching before the reset timing time is reached, stops the timer after the reset timing time is reached, evaluates an obtained count value by using a new threshold value, and sets a corresponding mobility state according to the result of the evaluation.

13. The method according to claim 12, wherein
the timer is stopped when the new timing time is not greater than the timing time which the timer has currently finished.

14. The method according to claim 11, wherein
time parameters contained in the evaluation parameters comprise trigger time and delay time; and
the completion of the mobility state evaluation refers to the reaching of the time timed by a timer for the trigger time, or the reaching of the time timed by a timer for the delay time.
